(19) United States
(12) Patent Application Publication
(10) Pub. No.: US 2008/0264021 A1
(43) Pub. Date: Oct. 30, 2008

(54) Cover for outdoor air conditioning unit having an air compressor disposed therein

(76) Inventor: John A. Hoover, Hurst, TX (US)

Correspondence Address: JAMES RAY & ASSOCIATES, 2640 PITCAIRN ROAD, MONROEVILLE, PA, 15146, US

(21) Appl. No.: 12/082,289

(22) Filed: Apr. 10, 2008

Related U.S. Application Data
(60) Provisional application No. 60/913,654, filed on Apr. 24, 2007.

(51) Int. Cl. B01D 46/00

(52) U.S. Cl. 55/493

(57) ABSTRACT

An apparatus to substantially minimize extraneous foreign material from entering an enclosure having a predetermined configuration for an outside air conditioning air compressor unit includes a frame member formed from a predetermined material and having a predetermined configuration substantially identical to the predetermined configuration for such outside air conditioning air compressor unit. At least one latch means engages with each free vertically disposed edge of such frame member for connecting them together to enclose such outside air conditioning air compressor unit. A pre-selected filter material is positioned in the frame member for substantially minimizing such extraneous foreign material from entering said enclosure for such outside air conditioning air compressor unit. A mechanism engages with each side of such filter material and with the frame member for retaining such filter material in position during use.

### CROSS REFERENCE TO RELATED APPLICATION

This patent application is related to and claims priority from U.S. Provisional Patent Application Ser. No. 60/913,654 filed Apr. 24, 2007.

### FIELD OF THE INVENTION

The present invention relates, in general, to air conditioner air compressors and, more particularly, this invention relates to a filter cover for such air conditioner air compressor unit to minimize extraneous foreign material from entering such air conditioner air compressor unit.

### BACKGROUND OF THE INVENTION

Prior to the conception and development of the present invention, as is generally well known in the prior art, many households, institutions, and businesses use air conditioning units in order to keep the interior of the building cool. Some households make use of window-unit air conditioners, however, most new structures are equipped with central air conditioning.

A central air conditioning unit normally consists of a series of ducts, vents and refrigeration tubing connected to a central unit placed outdoors. The unit, exterior and interior, must be kept clean in order to ensure proper and efficient functioning of the entire system. Should dirt and/or debris enter the unit, it could slowly, hinder the ability of the unit to function. Even worse, such unit could seize up completely.

### SUMMARY OF THE INVENTION

The present invention provides, in a first aspect, an apparatus to substantially minimize extraneous foreign material from entering a generally rectangular enclosure for an outside air conditioning air compressor unit. The apparatus includes a predetermined number of generally rectangular frame members formed from a predetermined material. A first means is engageable with adjacent vertically disposed edges of a first pair of such frame members for hingedly connecting them together. A second means is engageable with adjacent vertically disposed edges of a second pair of such frame members for hingedly connecting them together. There is a third means engageable with adjacent vertically disposed edges of such first and second pair of frame members for hingedly connecting them together also. At least one latch means is engageable with a free vertically disposed edge of each of such first pair of frame members and a free vertically disposed edge of such second pair of frame members for connecting them together to enclose such outside air conditioning air compressor unit. A pre-selected filter material is disposed in each of such predetermined number of generally rectangular frame members for substantially minimizing such extraneous foreign material from entering the generally rectangular enclosure for such outside air conditioning air compressor unit. Finally, there is a means engageable with each side of such filter material and with the generally rectangular frame members for retaining such filter material in position during use.

According to a second aspect, the invention provides, an apparatus to substantially minimize extraneous foreign material from entering a generally cylindrical enclosure for an outside air conditioning air compressor unit. The apparatus includes a generally cylindrical frame member formed from a predetermined material. There is at least one latch means engageable with each free vertically disposed edge of the generally cylindrical frame member for connecting them together to enclose such outside air conditioning air compressor unit. A pre-selected filter material is disposed in the generally cylindrical frame member for substantially minimizing such extraneous foreign material from entering the generally cylindrical enclosure for such outside air conditioning air compressor unit. Further, there is a means engageable with each side of the filter material and with such generally cylindrical frame member for retaining the filter material in position during use.

According to a third and final embodiment of the invention there is provided an apparatus to substantially minimize extraneous foreign material from entering an enclosure having a predetermined configuration for an outside air conditioning air compressor unit. In this embodiment the apparatus includes a frame member formed from a predetermined material. The frame member has a predetermined configuration substantially identical to the predetermined configuration for such outside air conditioning air compressor unit. At least one latch means is engageable with each free vertically disposed edge of such frame member for connecting them together to enclose such outside air conditioning air compressor unit. A pre-selected filter material is disposed in the frame member for substantially minimizing such extraneous foreign material from entering the enclosure for such outside air conditioning air compressor unit. Additionally, there is a means engageable with each side of the filter material and with such frame member for retaining the filter material in position during use.

### OBJECTS OF THE INVENTION

It is, therefore, one of the primary objects of the present invention to provide a cover for an outdoor air conditioning unit having an air compressor disposed therein which is easy to install.

Another object of the present invention is to provide a cover for an outdoor air conditioning unit having an air compressor disposed therein which is relatively inexpensive to manufacture.

Still another object of the present invention is to provide a cover for an outdoor air conditioning unit having an air compressor disposed therein which is relatively easy to maintain.

Yet another object of the present invention is to provide a cover for an outdoor air conditioning unit having an air compressor disposed therein which can be produced in a variety shapes, sizes and colors.

An additional object of the present invention is to provide a cover for an outdoor air conditioning unit having an air compressor disposed therein which will minimize repair and maintenance of the outdoor portion of an air conditioner unit.

In addition to the various objects and advantages of the present invention described with some degree of specificity above it should be obvious that additional objects and advantages of the present invention will become more readily apparent to those persons who are skilled in the relevant art from the following more detailed description of the invention, particularly, when such description is taken in conjunction with the attached drawing figures and with the appended claims.

### BRIEF DESCRIPTION OF THE DRAWINGS

FIG. 1 is a perspective view of one embodiment of a cover for a generally rectangular outdoor air conditioning unit having an air compressor disposed therein according to the present invention;

FIG. 2 is a perspective view of another embodiment of a cover for a generally cylindrical outdoor air conditioning unit having an air compressor disposed therein according to the present invention;

FIG. 3 is a broken view illustrating one form of a means for retaining a filter material in place;

FIG. 4 is a partial view illustrating a hinge used to connect adjacent panels;

FIG. 5 is a partial view illustrating a lock for the cover; and

FIG. 6 is a perspective view of another embodiment of a cover for an outdoor air conditioning unit having an air compressor disposed therein according to the present invention

### BRIEF DESCRIPTION OF A PRESENTLY PREFERRED AND VARIOUS ALTERNATIVE EMBODIMENTS OF THE INVENTION

Prior to proceeding to the more detailed description of the present invention it should be noted that, for the sake of clarity and understanding, identical components which have identical functions have been identified with identical reference numerals throughout the several views illustrated in the drawing figures.

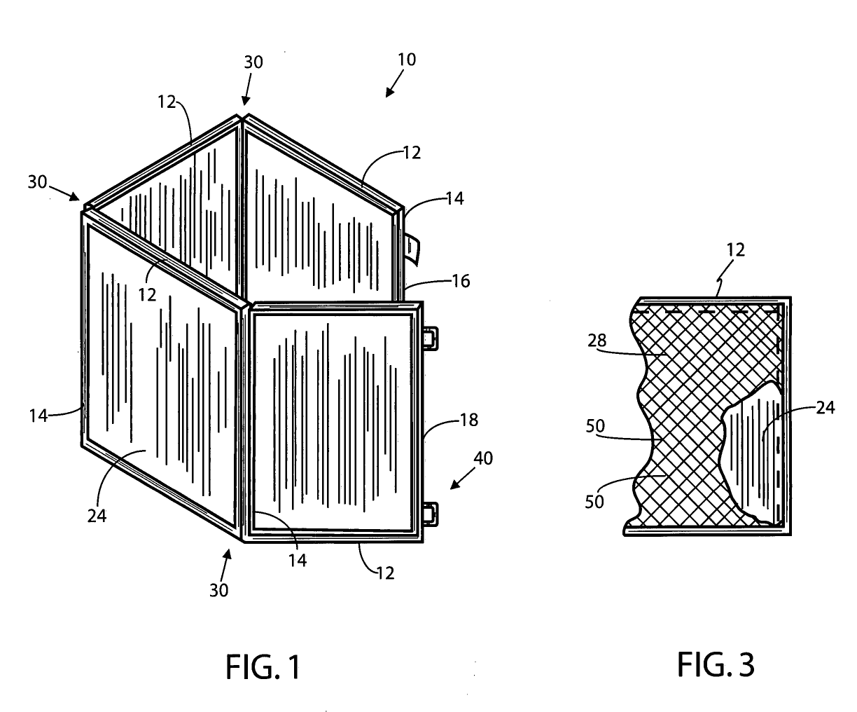

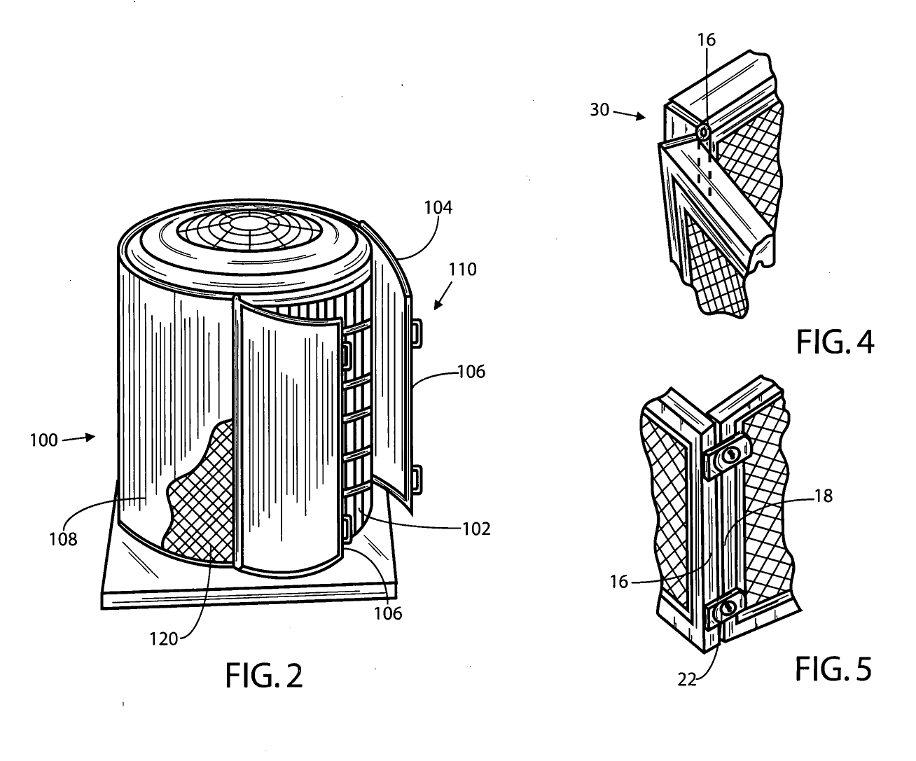

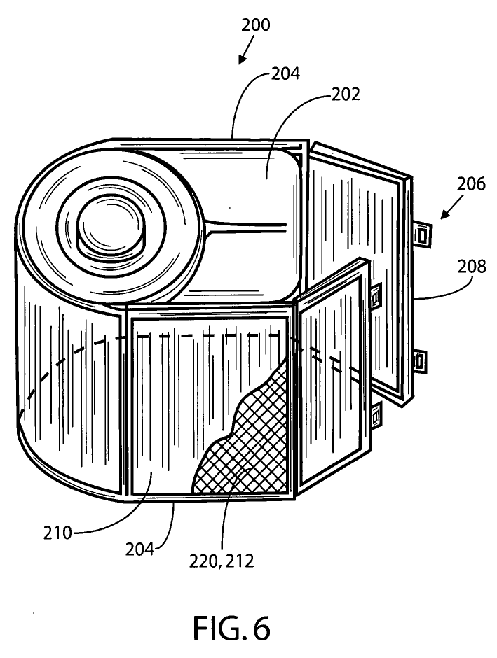

Reference is now made, more particularly, to FIGS. 1-6. Illustrated therein is one presently preferred embodiment of an apparatus, generally designated 10, which will substantially minimize any extraneous foreign material from entering a generally rectangular enclosure for an outside air conditioning air compressor unit (not shown) disposed within such enclosure.

The apparatus 10 includes a predetermined number of generally rectangular frame members 12 formed from a predetermined material. In this particular embodiment of the invention there are at least four such frame members 12. In the presently preferred embodiments of the invention such predetermined material is selected from the group consisting of plastic and metal. Preferably, the material is plastic tubing and the metal is aluminum.

A first means, generally designated 30, is engageable with adjacent vertically disposed edges 14 of a first pair of such frame members 12 for hingedly connecting them together. There is a second means 30 engageable with adjacent vertically disposed edges 14 of a second pair of frame members 12 for hingedly connecting them together. Further, a third means 30 is engageable with adjacent vertically disposed edges 14 of the first and second pair of said frame members 12 for hingedly connecting them together also.

At least one of such first, second and third means 30 engageable with the adjacent vertically disposed edges 14 of respective pairs of the frame members 12 for hingedly connecting them together is a continuous hinge member 16. Preferably, each of the first, second and third means 30 engageable with such adjacent vertically disposed edges 14 of respective pairs of frame members 12 for hingedly connecting them together are continuous hinge members.

Apparatus 10 further includes at least one latch means, generally designated 40, engageable with a free vertically disposed edge 16 of the first pair of frame members 12 and a free vertically disposed edge 18 of the second pair of frame members 12 for connecting them together to enclose such outside air conditioning air compressor unit. The at least one latch means includes at least one lock 22 for holding the respective free edges 16 and 18 of the first and second pair of frame members together.

Another essential element of this embodiment of the instant invention is a pre-selected filter material 24 disposed in each of the predetermined number of such generally rectangular frame members 12 for substantially minimizing such extraneous foreign material from entering the generally rectangular enclosure for such outside air conditioning air compressor unit. Such pre-selected filter material is preferably selected from the group consisting of fiber glass and foam.

The final essential element of this embodiment of the invention is a means, generally designated 50, that engages with each side of such filter material 24 and with the generally rectangular frame members 12 for maintaining such filter material 24 in position during use.

Means 50 engageable with each side of filter material 24 and with the generally rectangular frame members 12 for retaining the filter material 24 in position during use is a predetermined number of both substantially vertically disposed and horizontally disposed rod-like members 28 engaged with respective frame members 12.

According to a second embodiment of the invention, there is provided an apparatus, generally designated 100, which will substantially minimize extraneous foreign material from entering a generally cylindrical enclosure for a circular type outside air conditioning air compressor unit 102. This embodiment of the apparatus 100 includes a generally cylindrical frame member 104 formed from a predetermined material as described above with respect to the first embodiment.

Preferably, there is at least one latch means, generally designated 110, engageable with each free vertically disposed edge 106 of said generally cylindrical frame member 104 for connecting them together to enclose such outside air conditioning air compressor unit 102. Latch means 110 also includes a lock 22.

As with the first embodiment, this embodiment of the invention includes a pre-selected filter material 108 disposed in the generally cylindrical frame member 104 for substantially minimizing such extraneous foreign material from entering the generally cylindrical enclosure for such outside air conditioning air compressor unit 102. Such filter material 108 would be essentially the same as in the first embodiment described above.

Lastly, there is a means, generally designated 120, engageable with each side of the filter material 108 and with such generally cylindrical frame member 104 for retaining the filter material 108 in position during use.

According to a third and final embodiment of the invention, there is provided an apparatus, generally designated 200, to substantially minimize extraneous foreign material from entering an enclosure which has a predetermined configuration for an air conditioning air compressor unit 202 located outside. This apparatus 200 includes a frame member 204 formed from a predetermined material and having a predetermined configuration substantially identical to the predetermined configuration for such outside air conditioning air compressor unit 202. The predetermined material for frame member 204 is essentially the same as described above.

Apparatus 200 further includes at least one latch means 206 engageable with each free vertically disposed edge 208 of such frame member 204 for connecting them together to enclose such outside air conditioning air compressor unit 202.

There is a pre-selected filter material 210 disposed in the frame member 204 for substantially minimizing such extraneous foreign material from entering said enclosure for such outside air conditioning air compressor unit 202. Also a means, generally designated 220, engageable with each side of such filter material 210 and with the frame member 204 for retaining the filter material 210 in position during use is provided.

Preferably, the means 220 engageable with each side of such filter material 210 and with such frame member 204 for retaining the filter material 210 in position during use is a wire mesh type material such as a screen 212. Screen 212 is one of plastic and metal and can be used in any one of the three embodiments described above.

While a presently preferred and various alternative embodiments of the present invention have been described in sufficient detail above to enable a person skilled in the relevant art to make and use the same it should be obvious that various other adaptations and modifications can be envisioned by those persons skilled in such art without departing from either the spirit of the invention or the scope of the appended claims.

I claim:

1. An apparatus to substantially minimize extraneous foreign material from entering a generally rectangular enclosure for an outside air conditioning air compressor unit, said apparatus comprising:
(a) a predetermined number of generally rectangular frame members formed from a predetermined material;
(b) a first means engageable with adjacent vertically disposed edges of a first pair of said frame members for hingedly connecting them together;
(c) a second means engageable with adjacent vertically disposed edges of a second pair of said frame members for hingedly connecting them together;
(d) a third means engageable with adjacent vertically disposed edges of said first and said second pair of said frame members for hingedly connecting them together;
(e) at least one latch means engageable with a free vertically disposed edge of said first pair of said frame members and a free vertically disposed edge of said second pair of said frame members for connecting them together to enclose such outside air conditioning air compressor unit;
(f) a pre-selected filter material disposed in each of said predetermined number of said generally rectangular frame members for substantially minimizing such extraneous foreign material from entering said generally rectangular enclosure for such outside air conditioning air compressor unit; and
(g) a means engageable with each side of said filter material and with said generally rectangular frame members for retaining said filter material in position during use.

2. An apparatus, according to claim 1, wherein said predetermined number of generally rectangular frame members is at least four.

3. An apparatus, according to claim 1, wherein said predetermined material is selected from the group consisting of plastic and metal.

4. An apparatus, according to claim 3, wherein said predetermined material is plastic tubing.

5. An apparatus, according to claim 3, wherein said metal is aluminum.

6. An apparatus, according to claim 1, wherein at least one of said first, said second and said third means engageable with said adjacent vertically disposed edges of respective pairs of said frame members for hingedly connecting them together is a continuous hinge member.

7. An apparatus, according to claim 6, wherein each of said first, said second and said third means engageable with said adjacent vertically disposed edges of respective pairs of said frame members for hingedly connecting them together are continuous hinge members.

8. An apparatus, according to claim 6, wherein said pre-selected filter material is selected from the group consisting of fiber glass and foam.

9. An apparatus, according to claim 1, wherein said means engageable with each side of said filter material and with said generally rectangular frame members for retaining said filter material in position during use is a predetermined number of both substantially vertically disposed and horizontally disposed rod-like members engaged with respective frame members.

10. An apparatus, according to claim 1, wherein said latch means includes a lock.

11. An apparatus to substantially minimize extraneous foreign material from entering a generally cylindrical enclosure for an outside air conditioning air compressor unit, said apparatus comprising:
(a) a generally cylindrical frame member formed from a predetermined material;
(b) at least one latch means engageable with each free vertically disposed edge of said generally cylindrical frame member for connecting them together to enclose such outside air conditioning air compressor unit;
(c) a pre-selected filter material disposed in said generally cylindrical frame member for substantially minimizing such extraneous foreign material from entering said generally cylindrical enclosure for such outside air conditioning air compressor unit; and
(d) a means engageable with each side of said filter material and with said generally cylindrical frame member for retaining said filter material in position during use.

12. An apparatus, according to claim 11, wherein said predetermined material is selected from the group consisting of plastic and metal.

13. An apparatus, according to claim 12, wherein said predetermined material is tubing.

14. An apparatus, according to claim 11, wherein said latch means includes a lock.

15. An apparatus to substantially minimize extraneous foreign material from entering an enclosure having a predetermined configuration for an outside air conditioning air compressor unit, said apparatus comprising:
(a) a frame member formed from a predetermined material and having a predetermined configuration substantially identical to said predetermined configuration for such outside air conditioning air compressor unit;
(b) at least one latch means engageable with each free vertically disposed edge of said frame member for connecting them together to enclose such outside air conditioning air compressor unit;
(c) a pre-selected filter material disposed in said frame member for substantially minimizing such extraneous foreign material from entering said enclosure for such outside air conditioning air compressor unit; and
(d) a means engageable with each side of said filter material and with said frame member for retaining said filter material in position during use.

16. An apparatus, according to claim 15, wherein said means engageable with each side of said filter material and with said frame member for retaining said filter material in position during use is a wire mesh material.

17. An apparatus, according to claim 15, wherein said means engageable with each side of said filter material and with said frame member for retaining said filter material in position during use is a screen.

18. An apparatus, according to claim 17, wherein said screen is one of plastic and metal.
